(19) United States
(12) Patent Application Publication
(10) Pub. No.: US 2001/0033142 A1
(43) Pub. Date: Oct. 25, 2001

(54) Apparatus for driving an automatic door to reciprocate

(76) Inventor: Lin Wan-Sheng, Tai-Ping City (TW)

Correspondence Address: OSTROLENK FABER GERB & SOFFEN, 1180 AVENUE OF THE AMERICAS, NEW YORK, NY, 100368403

(21) Appl. No.: 09/833,374

(22) Filed: Apr. 12, 2001

(30) Foreign Application Priority Data
Apr. 20, 2000 (TW) 089206446

(51) Int. Cl. H02P 1/00; H02P 3/00; G05B 5/00; H02P 7/00; H02H 7/08

(52) U.S. Cl. 318/445

(57) ABSTRACT

An apparatus for driving an automatic door to reciprocate includes an elongated horizontal mounting member, and a sliding block disposed slidably on the mounting member. A left cable has a first end fastened to one of a left end of the mounting member and a left side of the block, and a second end fastened to a left side of the door. A right cable has a first end fastened to one of a right end of the mounting member and a right side of the block, and a second end fastened to a right side of the door. Each of the left and right cables has an intermediate portion, which is guided to extend along a snakelike path and which includes a plurality of parallel horizontal cable portions that are arranged one above another and that extend in a longitudinal direction of the mounting member. As such, the distance traveled by the door can be several times that of the sliding block.

### BACKGROUND OF THE INVENTION

1. Field of the Invention

This invention relates to an apparatus for driving an object to reciprocate, more particularly to an apparatus for driving an automatic door to reciprocate, which includes a sliding block, and two cables, each of which is driven by the sliding block to move along a snakelike path.

2. Description of the Related Art

Referring to FIG. 1, a conventional driving apparatus for an automatic door 10 is shown to include an elongated horizontal mounting member 20, and a motor 21 disposed on a right end of a vertical side wall 201 of the mounting member 20. A guiding roller 22 is disposed on a left end of the side wall 201. An endless belt 23 extends around the guiding roller 22 and an output wheel 211 of the motor 21. The door 10 includes a left half 11 and a right half. The left half 11 is fastened to a left half portion of an upper horizontal belt portion 231 of the belt 23 by means of a connecting element 13, while the right half 12 is fastened to a right half portion of a lower horizontal belt portion 232 of the belt 23 by means of another connecting element 14. The mounting member 20 further has a horizontal bottom wall 202, which extends from a lower end of the side wall 201 and which is formed with an integral guiding rail 24. Each of the left and right halves 11,12 of the door 10 is formed with a fixed connecting plate 15, 16, each of which is provided with a roller 151, 161, which moves along the guiding rail 24. The aforesaid conventional driving apparatus suffers from the following disadvantages:

(1) Because the mounting member 20 is longer than the distances traveled by the left and right halves 11, 12 of the door 10, it cannot be standardized. As a result, it is impossible to mass-produce the driving apparatus.

(2) To ensure that the belt 23 can extend around the roller 22 and the output wheel 211 during assembly, the belt 23 is designed to have an actual length slightly longer than the ideal length. Hence, the belt 23 is too long to move on the mounting member 20 under tension, thereby resulting in unsmooth movement of the left and right halves 11, 12 of the door 10.

(3) The mounting member 20 is relatively long, thereby increasing the total volume of the driving apparatus.

### SUMMARY OF THE INVENTION

It is an object of this invention to provide a compact driving apparatus for an automatic door, which is suitable for mass-production and which can ensure smooth movement of the door.

According to this invention, an apparatus for driving an automatic door to reciprocate includes an elongated horizontal mounting member, and a sliding block disposed slidably on the mounting member. A left cable has a first end fastened to one of a left end of the mounting member and a left side of the block, and a second end fastened to a left side of the door. A right cable has a first end fastened to one of a right end of the mounting member and a right side of the block, and a second end fastened to a right side of the door. Each of the left and right cables has an intermediate portion, which is guided to extend along a snakelike path and which includes a plurality of parallel horizontal cable portions that are arranged one above another and that extend in a longitudinal direction of the mounting member. As such, the distance traveled by the door can be several times that of the sliding block. Because the length of the mounting member is determined regardless of the desired traveling distance of the door, it can be standardized and shortened to an appropriate size, thereby permitting mass production thereof. Furthermore, because excessive length of the left and right cables can be cut off after completing assembly of the apparatus so as to permit extension of the left and right cables on the mounting member under tension, the door can move smoothly.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a fragmentary perspective view of a conventional driving apparatus for an automatic door;

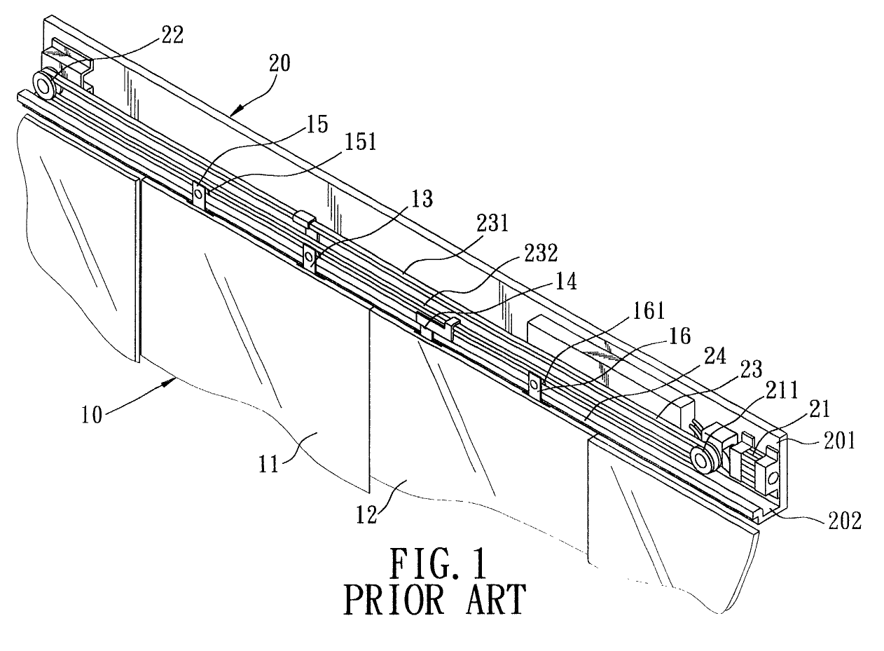

FIG. 2 is an exploded view of a first preferred embodiment of a driving apparatus for an automatic door according to this invention, in which each of first left and right cables has an intermediate portion that extends along a snakelike path and that includes four parallel horizontal cable portions;

FIG. 3 is a fragmentary perspective view of the first preferred embodiment;

FIG. 4 is a schematic front view of the first preferred embodiment when the door is at an open state;

FIG. 5 is a schematic front view of the first preferred embodiment when the door is at a closed state;

FIG. 6 is a schematic front view, illustrating the travel multiplication of the door relative to a first sliding block of the first preferred embodiment;

FIG. 7 is a schematic front view of a second preferred embodiment of a driving apparatus for an automatic door according to this invention, in which each of first left and right cables has an intermediate portion that extends along a snakelike path and that includes six parallel horizontal cable portions;

FIG. 8 is a fragmentary perspective view of a third preferred embodiment of a driving apparatus for an automatic door according to this invention, which is provided with a hydraulic cylinder that serves as a first driving unit;

FIG. 9 is a schematic front view of a fourth preferred embodiment of a driving apparatus for an automatic door according to this invention, illustrating a modified first driving unit;

FIG. 10 is a schematic front view of a fifth preferred embodiment of a driving apparatus for an automatic door according to this invention, in which an end of each of first left and right cables is fastened to a first mounting member; and

FIG. 11 is a schematic front view of a sixth preferred embodiment of a driving apparatus for an automatic door according to this invention, in which an end of each of first left and right cables is fastened to a first sliding block.

### DETAILED DESCRIPTION OF THE PREFERRED EMBODIMENTS

Before the present invention is described in greater detail in connection with the preferred embodiments, it should be noted that similar elements and structures are designated by like reference numbers throughout the entire disclosure.

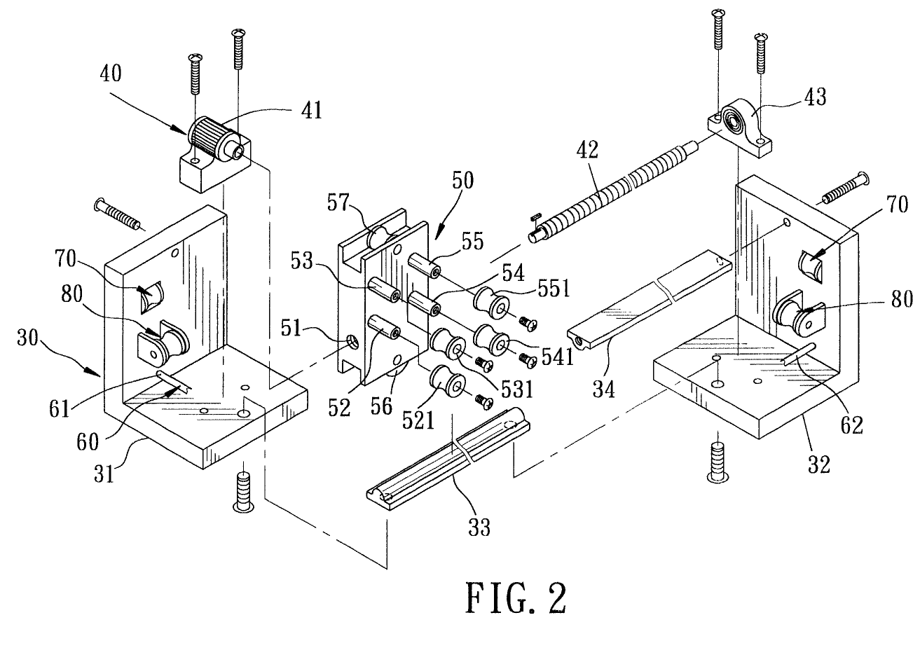

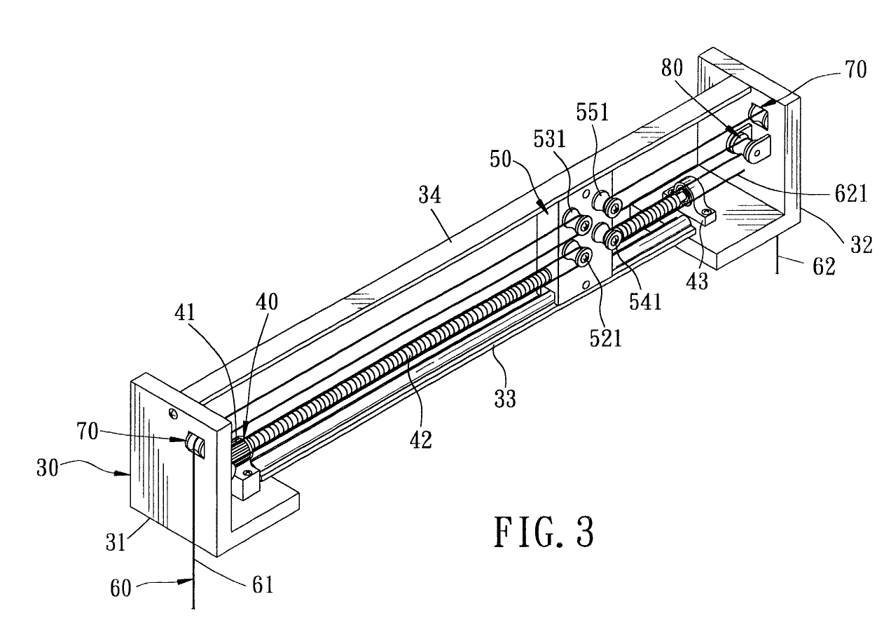

Referring to FIGS. 2, 3, and 4, a first preferred embodiment of an apparatus for driving an automatic door 90 to reciprocate is shown to include an elongated stationary horizontal first mounting member 30, a first driving unit 40, a first sliding block 50, and a first cable unit 60.

The first mounting member 30 is disposed over the door 90, and has a left end with an L-shaped left bracket 31, and a right end with an L-shaped right bracket 32. The left and right brackets 31, 32 are provided respectively with a first left cable-guiding unit, and a first right cable-guiding unit, each of which includes a left upper guiding roller 70 and a first intermediate guiding roller 80.

The first driving unit 40 includes a motor 41 disposed on the left end of the first mounting member 30, and a threaded rod 42 that is journalled on a bearing unit 43 and that extends threadably through a threaded hole 51 in the first sliding block 50. Because the threaded rod 42 is connected fixedly to an output shaft of the motor 41, when the threaded rod 42 is rotated by the motor 41, the first sliding block 50 moves horizontally on the first mounting member 30.

The first sliding block 50 has a left side with a first left cable-guiding unit, and a right side with a first right cable-guiding unit. The first left cable-guiding unit of the first sliding block 50 includes two horizontal projecting rods 52, 53, on which two rollers 521, 531 are sleeved rotatably. Similarly, the first right cable-guiding unit of the first sliding block 50 includes two horizontal projecting rods 54, 55, on which two rollers 541, 551 are sleeved rotatably. The first sliding block 50 further includes a lower roller 56 that is disposed rotatably on a lower end thereof and that is movable along a guiding rail 33 of the first mounting member 30.

A pair of first left and right lower guiding members 100 are disposed respectively under the left and right brackets 31, 32, and are located at the same level. In this embodiment, the guiding members 100 are constructed as rollers.

The first cable unit Go consists of a first left cable 61 and a first right cable 62. The first left cable 61 extends around the first left lower guiding member 100, and has a first end 611 that is fastened to the left bracket 31, a second end 612 that is fastened to a left side of the door 90, and a left lower horizontal cable portion 613 located between the second end 612 and the first left lower guiding member 100. An intermediate portion of the first left cable 61 extends along a snakelike path between the left rollers 70, 80 and the rollers 521, 531, and includes four parallel left upper horizontal cable portions 614 arranged one above another and extending in a longitudinal direction of the first mounting member 30. Similarly, the first right cable 62 extends around the first right lower guiding member 100, and has a first end 621 that is fastened to the right bracket 31, a second end 622 that is fastened to a right side of the door 90, and a right lower horizontal cable portion 623 located between the second end 622 and the first right lower guiding member 100. An intermediate portion of the first right cable 62 extends along a snakelike path between the right rollers 70, 80 and the rollers 521, 531, and includes four parallel right upper horizontal cable portions 624.

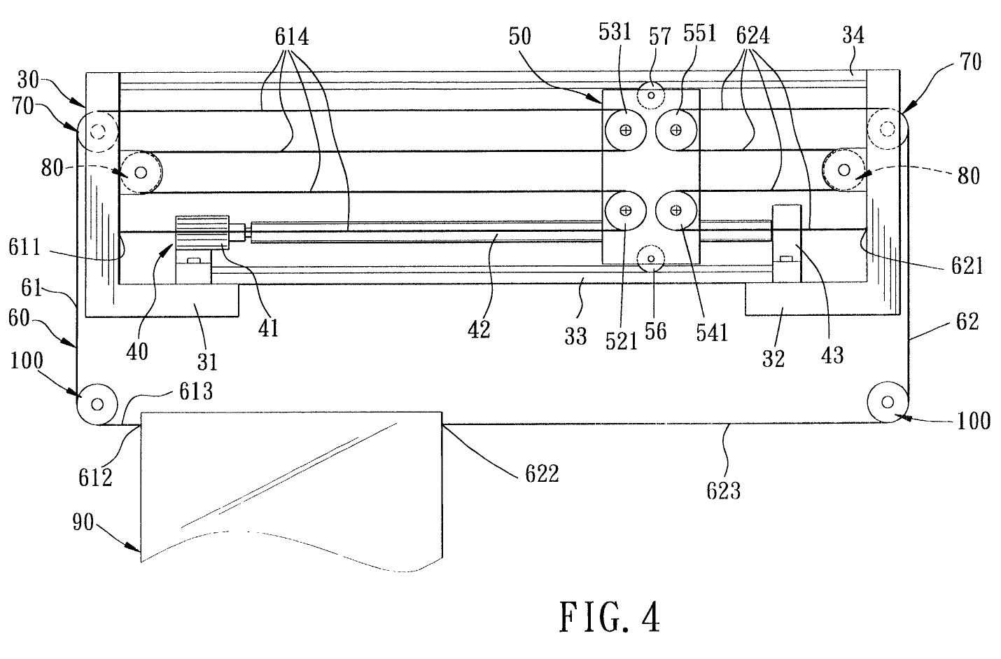

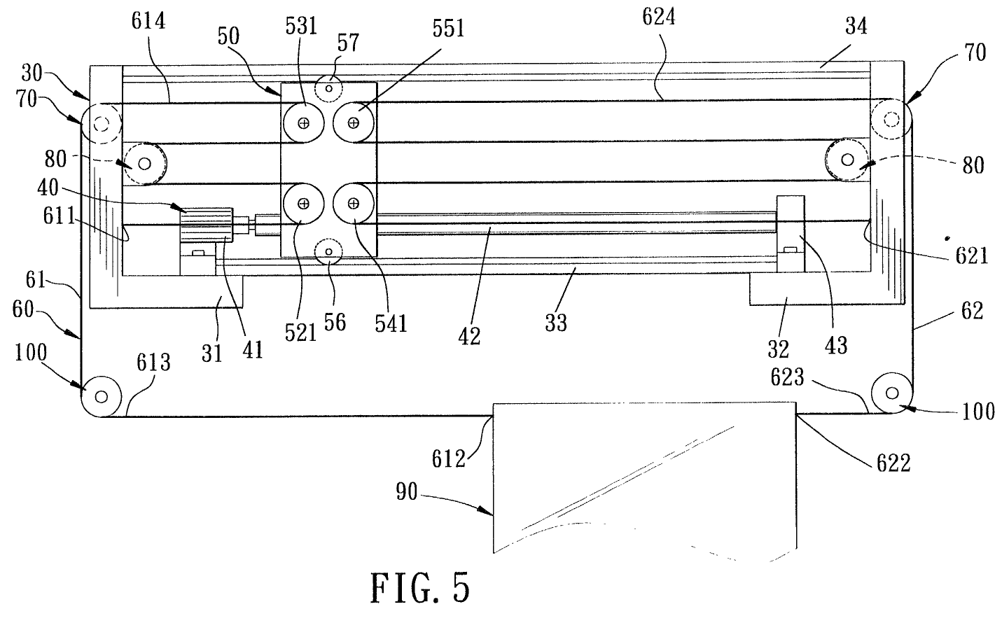

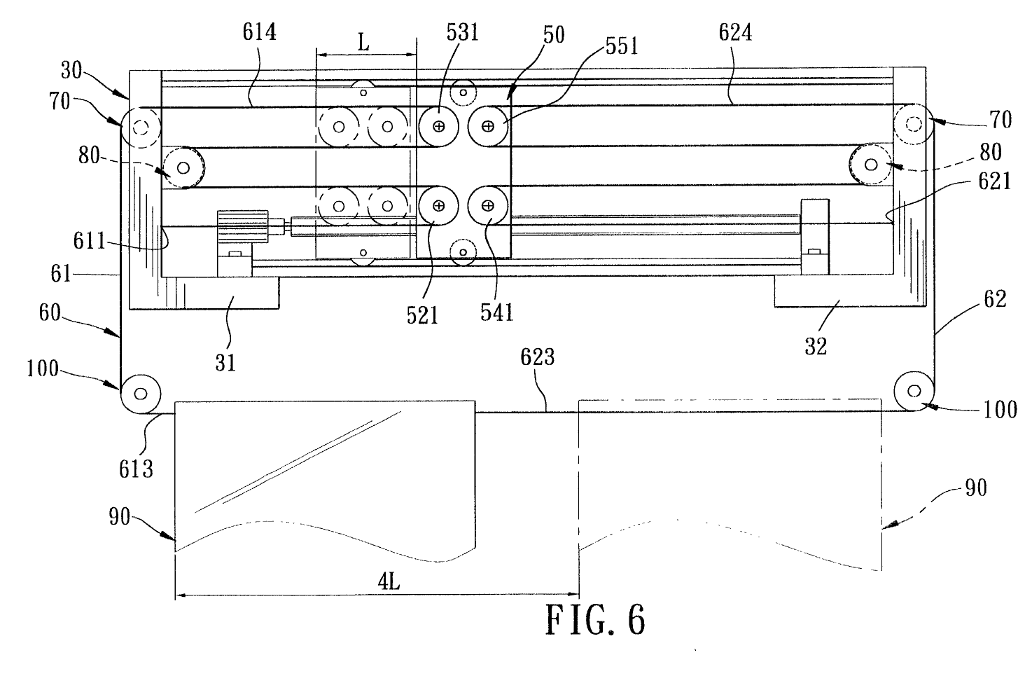

As such, the door 90 can move between an open position shown in FIG. 4 and a closed position shown in FIG. 5. Referring to FIG. 6, when the first sliding block 50 is moved from a position shown in the phantom lines to that shown in the solid lines, which are spaced apart from each other at a first small distance (L), the door 90 moves a first large distance (4L), which is four times the first small distance (L), in view of the condition that the number of the left upper horizontal cable portions 614 is four. Accordingly, when the distances traveled by the first sliding block 50 and the door 90 are indicated by (Tb) and (Td), respectively, and the number of the cable portions 614 is indicated by (N), the relationship between the distances traveled by the first sliding block 50 and the door 90 can be designed by the equation: Td=Tb×N.

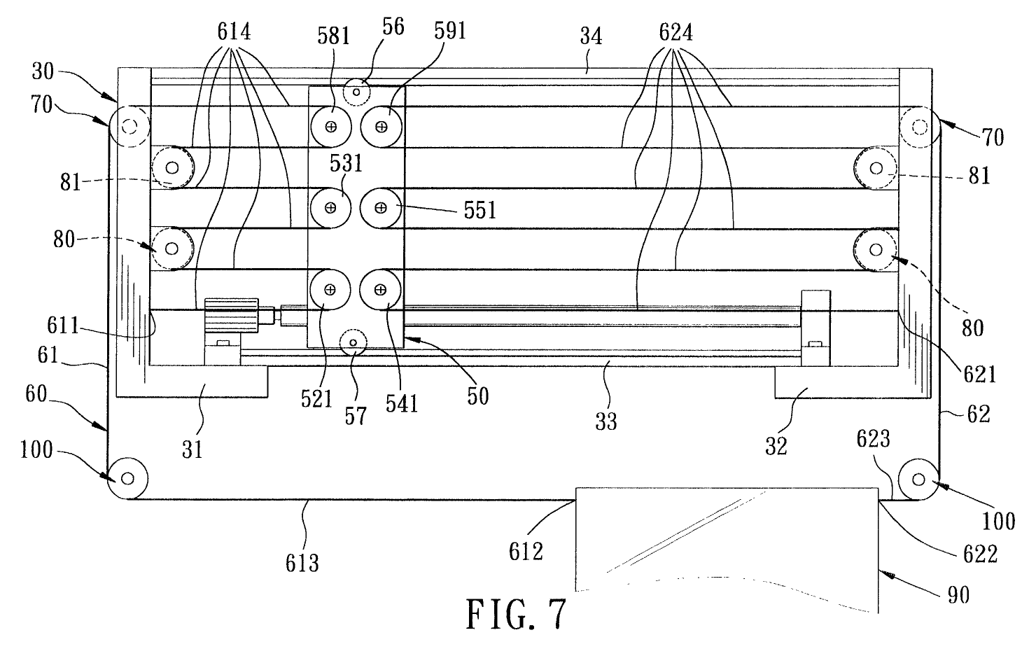

The number of the left and right upper horizontal cable portions 614, 624 can be increased. For example, as shown in FIG. 7, the number of the left upper horizontal cable portions 614 is increased to six by adding two first intermediate guiding rollers 81 disposed respectively on the first left and right brackets 31, and two rollers 581, 591 disposed respectively on the left and right sides of the first sliding block 50.

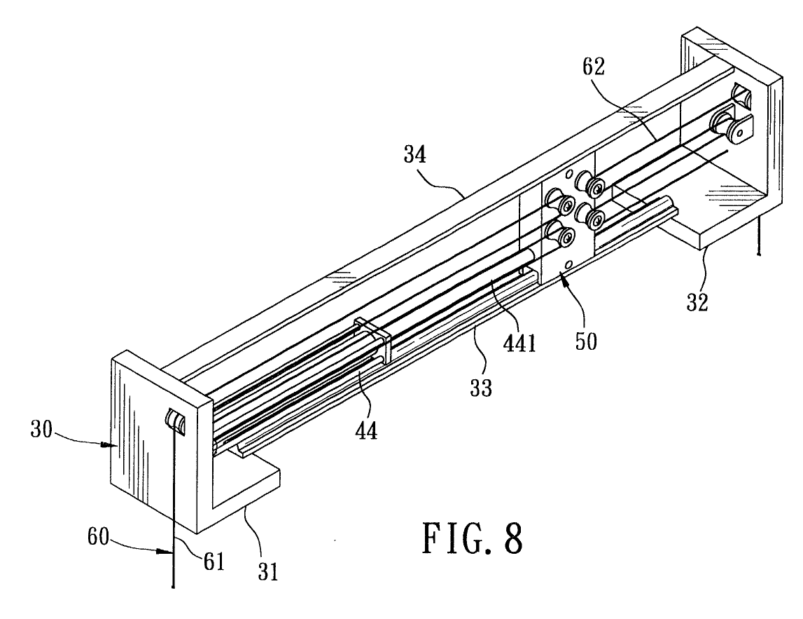

FIG. 8 illustrates a modified first driving unit, which includes a hydraulic cylinder 44 that is provided with a horizontally movable piston rod 441, to which the first sliding block 50 is fixed.

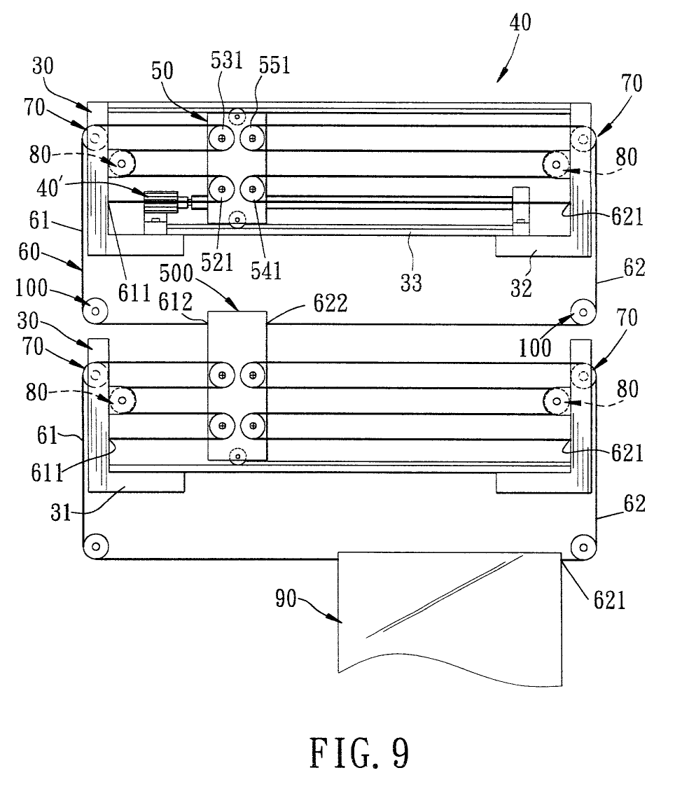

FIG. 9 illustrates another modified first driving unit 40, which is similar to the apparatus shown in FIG. 5 in construction, which is disposed over the first mounting member 30, and which includes a second mounting member 30, a second driving unit 40′, a second sliding block 50, a pair of second left and right lower guiding members 100, a second left cable 61, and a second right cable 62.

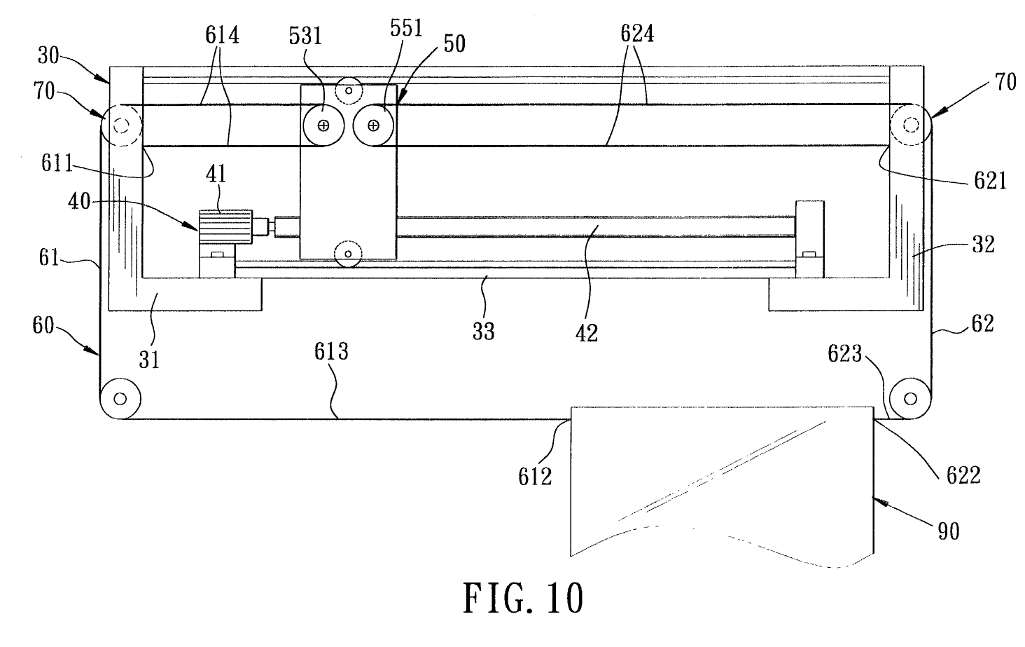

Referring to FIG. 10, the number of the left upper horizontal cable portions 614 is reduced to two. In this embodiment, the first end 611 of the first left cable 61 is fastened to the first left bracket 31.

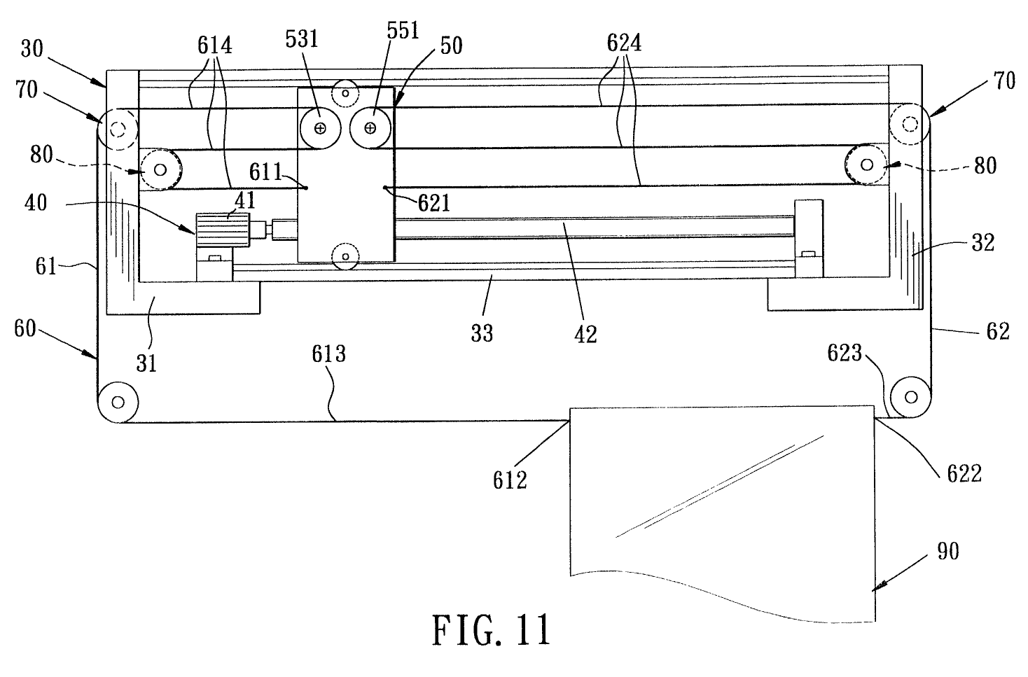

Referring to FIG. 11, the number of the left upper horizontal cable portions 614 is three. In this embodiment, the first end 611 of the first left cable 61 is fastened to the first sliding block 50.

This invention has the following advantages:

(1) The distance traveled by the door 90 can be several times that of the first sliding block 50. Because the length of the mounting member is determined regardless of the desired traveling distance of the door 90, it can be standardized and shortened to an appropriate size, thereby permitting mass production thereof.

(2) Because excessive length of the first and second left and right cables 61, 62 can be cut off after completing assembly of the apparatus so as to permit extension of the first left and right cables 61, 62 on the first mounting member 30 under tension, the door 90 can move smoothly.

Note that the driving apparatus of this invention can also be applied to drive an object other than the automatic door, such as a movable toy.

With this invention thus explained, it is apparent that numerous modifications and variations can be made without departing from the scope and spirit of this invention. It is therefore intended that this invention be limited only as indicated by the appended claims.

I claim:

1. An apparatus for driving an automatic door to reciprocate, the door having a left side and a right side, said apparatus comprising:
an elongated stationary horizontal first mounting member adapted to be disposed over the door and having a left end with a first left cable-guiding unit, and a right end with a first right cable-guiding unit;
a first driving unit;
a first sliding block driven by said first driving unit to reciprocate horizontally on said first mounting member and having a left side with a first left cable-guiding unit, and a right side with a first right cable-guiding unit;
a pair of first left and right lower guiding members disposed respectively under said left and right ends of said first mounting member and located at the same level;
a first left cable extending around said left lower guiding member and having a first end that is fastened to one of said left end of said first mounting member and said first sliding block, a second end that is adapted to be fastened to the left side of the door, a left lower horizontal cable portion located between said second end of said first left cable and said left lower guiding member, and a first predetermined number of left upper horizontal cable portions formed between said first left cable-guiding units of said first sliding block and said first mounting member under tension one above another; and
a first right cable extending around said right lower guiding member and having a first end that is fastened to one of said right end of said first mounting member and said first sliding block, a second end that is adapted to be fastened to the right side of the door, a right lower horizontal cable portion located between said second end of said first right cable and said right lower guiding member, and the first predetermined number of right upper horizontal cable portions formed between said first right cable-guiding units of said first sliding block and said first mounting member under tension one above another, said first sliding block being capable of being moved a first small distance in a predetermined direction so as to be adapted to move the door between said first left and right lower guiding members by a first large distance in the predetermined direction, wherein when the distance traveled by said first sliding block and the door are indicated by (Tb) and (Td), respectively, and the number of the first left upper horizontal cable portions is indicated by (N), the relationship between the distances traveled by said first sliding block and the door is designed by the equation: Td=Tb×N.

2. The apparatus as claimed in claim 1, wherein each of said first left and right lower guiding members is constructed as a roller.

3. The apparatus as claimed in claim 1, wherein said first sliding block is formed with a threaded hole therethrough, said first driving unit including:
a motor disposed on said first mounting member; and
a threaded rod extending threadably through said threaded hole in said first sliding block and rotated by said motor to move said first sliding block on said first mounting member.

4. The apparatus as claimed in claim 1, wherein said first driving unit includes a hydraulic cylinder, which is disposed on said first mounting member and which is provided with a horizontally movable piston rod that is connected to said first sliding block.

5. The apparatus as claimed in claim 1, wherein each of said left and first right cable-guiding units of said first mounting member and said first sliding block includes a roller.

6. The apparatus as claimed in claim 1, wherein each of said left and first right cable-guiding units of said first mounting member and said first sliding block includes two rollers, which are arranged one above another.

7. The apparatus as claimed in claim 1, wherein each of said left and first right cable-guiding units of said first mounting member and said first sliding block includes three rollers, which are arranged one above another.

8. The apparatus as claimed in claim 1, wherein said first driving unit includes:
an elongated stationary horizontal second mounting member adapted to be disposed over said first mounting member and having a left end with a second left cable-guiding unit, and a right end with a second right cable-guiding unit;
a second driving unit;
a second sliding block driven by said second driving unit to reciprocate horizontally on said second mounting member and having a left side with a second left cable-guiding unit, and a right side with a second right cable-guiding unit;
a pair of second left and right lower guiding members disposed respectively under said left and right ends of said second mounting member and located at the same level;
a second left cable extending around said left lower guiding member and having a first end that is fastened to one of said left end of said second mounting member and said second sliding block, a second end that is fastened to the left side of said first sliding block, a left lower horizontal cable portion located between said second end of said second left cable and said left lower guiding member, and a second predetermined number of left upper horizontal cable portions formed between said second left cable-guiding units of said second sliding block and said second mounting member under tension one above another; and
a second right cable extending around said right lower guiding member and having a first end that is fastened to one of said right end of said second mounting member and said second sliding block, a second end that is fastened to the right side of said first sliding block, a right lower horizontal cable portion located between said second end of said second right cable and said right lower guiding member, and the second predetermined number of right upper horizontal cable portions formed between said second right cable-guiding units of said second sliding block and said second mounting member under tension one above another, said second sliding block being capable of being moved a second small distance in the predetermined direction so as to be adapted to move said first sliding block between said second left and right lower guiding members by a second large distance in the predetermined direction.
